(19) United States
(12) Patent Application Publication
(10) Pub. No.: US 2017/0210047 A1
(43) Pub. Date: Jul. 27, 2017

(54) HYDRAULIC DEVICE FOR FORMING A MACHINE

(71) Applicant: ENGEL AUSTRIA GmbH, Schwertberg (AT)

(72) Inventors: Markus OTTO, Behamberg (AT); Anton LOHNECKER, Ertl (AT)

(21) Appl. No.: 15/407,698

(22) Filed: Jan. 17, 2017

(30) Foreign Application Priority Data
Jan. 22, 2016 (AT) A 24/2016

(51) Int. Cl. B29C 45/17; B29C 45/82; B29C 45/03

(52) U.S. Cl. CPC B29C 45/17; B29C 45/03; B29C 45/82; B29C 2945/76933; B29C 2945/76936

(57) ABSTRACT

A hydraulic device for a molding machine includes a first pump for a hydraulic fluid, a second pump for the hydraulic fluid, and a drive device for the first pump and the second pump. A first main conduit leads away from the first pump, and a second main conduit leads away from the second pump. A first consumer is connected with the first main conduit via a first opening and a first sub-conduit, and the first consumer is connected with the second main conduit via a second opening and a second sub-conduit. A second consumer is also connected with one of the main conduits via a third opening and a third sub-conduit. The second consumer is connected with the first main conduit via the third opening and the third sub-conduit, and is connected with the second main conduit via a fourth opening and a fourth sub-conduit.

The invention concerns a hydraulic device for a molding machine, in particular an injection molding machine, comprising a first pump for a hydraulic fluid, at least a second pump for the hydraulic fluid, at least one drive device for the first pump and the second pump, a first main conduit which leads away from the first pump, a second main conduit which leads away from the second pump, a first consumer which is connected with the first main conduit via a first opening and a first sub-conduit and which is connected with the second main conduit via a second opening and a second sub-conduit, and at least one second consumer which is also connected with one of the main conduits via a third opening and a third sub-conduit. Moreover, the invention concerns a molding machine with such a hydraulic device.

Hydraulic devices are used in diverse manners in the molding machine industry. For example, core pulls, mold mounting platens, ejectors, etc. can be moved with consumers of such a hydraulic device.

An example for such a hydraulic device is disclosed in the DE 196 21 907 A1 in which a drive of hydraulic working machines is described. There, the pressure side of the first pump is connected with the intake side of a consumer and the pressure side of the second pump is connected with the discharge side of a consumer (in this case referenced with 1). The adjusting pump works conveying whereas the other works swallowing and fulfills the function of a proportional valve without creating its pressure losses. In this document it is indeed also mentioned that several consumers (referenced with 2, 3, 4 and 5) can be actuated, however, there is no hint that the actuating manner of the first-mentioned consumer could also be used for several consumers. Rather, the further consumers are actuated in such a way that in these cases each discharge side of the consumer is led into the tank. Also the motion direction of these further consumers is not actuated via the pumps but via a 4/3-way valve.

Also the EP 1 181 458 B1 shows a similar hydraulic drive with several hydraulic consumers also comprising a differential cylinder. Also in this case the pressure side of the first pump is connected with the intake side of a consumer and the pressure side of the second pump is connected with the discharge side of a consumer (in this case indicated with 10). Among other things it is mentioned that drives would already exist where the two hydro machines serve for the pressure means supply of a single hydraulic consumer. Further, the hydro pumps should supply additional consumers, wherein it is emphasized that these consumers are actuated via way valves and their discharging side is connected on tank. Thus, also in this document the control of a consumer with two hydro pumps is used for only one consumer and not for several consumers.

The object of the present invention, thus, is to create an improved hydraulic device compared to the state of the art. In particular, the hydraulic device should be more efficient.

This object is solved by a hydraulic device with the features of claim 1. Accordingly, the second consumer on the one hand is connected with the first main conduit via the third opening and the third sub-conduit and on the other hand is connected with the second main conduit via a fourth opening and a fourth sub-conduit. Thus, also the second consumer is each connected via separate sub-conduits and openings once with the first main conduit and once with the second main conduit. Therefore, also this second consumer can be used at least as sufficient as the first consumer. Especially, however, the whole hydraulic device works more efficient.

A particular advantage of this invention is its energy efficiency because the pumps are specifically driven with the required amounts. Moreover, no sophisticated throttling is necessary. An energy recovery is also possible by the back flowing pump, as either the two pumps are arranged on one axis or the pumps are connected to each other via an electric intermediate circuit. Also possible valves in the sub-conduits can be differently (large). These valves can be formed as simple switch valves (no sophisticated 4/3-way valves) and can be adapted to the size of each consumer, which in turn is conducive for the energy efficiency. Said points are also substantially conducive in order to being able to minimize the throttle losses, whereby also a hydraulic cooling can be spared. Moreover, less oil amount in the tank is required and the hydraulic oil has a longer operational lifetime as the hydraulic oil is less warmed or stressed.

Preferred embodiments of the present invention are noted in the sub-claims.

For example it is preferably provided that the consumers are formed as piston-cylinder units or as hydro motors. Also different kinds of consumers can be provided in the same hydraulic device. Especially, if the consumer is formed as piston-cylinder unit, it is preferably provided that the first and third opening each lead to a piston-sided cavity in the cylinder of the respective piston-cylinder unit and the second and fourth opening each lead to a rod-sided cavity in the cylinder of the respective piston-cylinder unit.

In principle it is sufficient if the dispensation of the hydraulic fluid to the single consumers is effected only via the pumps. Preferably, however, it is also provided that valves, preferably 2/2-way valves, are arranged in each sub-conduit. Thus, also the valves can be used for the exact dispensation of the hydraulic fluid to the respective consumer. According to a preferred embodiment these valves can take on only two functions: On the one hand the loss-free and, thus, energetically optimal holding of the position and on the other hand the preventing of undesired movements of further consumers.

Regarding the principle construction of the drive device two alternative variants are possible. On the one hand it can be provided that the at least one drive device, which is preferably formed as an electro or hydro motor, drives both pumps. In this case both pumps can be connected with the one drive device via a common shaft. On the other hand it can also be provided that at least two drive devices are provided, wherein each drive device each drives one of the pumps. In this case these drive devices are then signally connected to each other.

It is per se possible that the function of the individual pumps is effected via simple circuitry. Also, a user can carry out all pump adjustments for example via corresponding control buttons. Preferably, however, an open or closed loop control unit for controlling or regulating the pumps is provided. In order to be able to more efficiently using the open or closed loop control unit, it is preferably provided that also the valves can be controlled via the open or closed loop control unit.

It is of a particular control-wise advantage if consumer-specific data, for example feeding volumes and/or areal ratios of the consumers, are stored in the open or closed loop control unit. Thereby, the pumps can be controlled by the open or closed loop control unit in dependence of the consumer-specific data. Alternatively or additionally the pumps can be controlled by the open or closed loop control unit in dependence of motion profiles of the consumers, preferably stored in a memory. These motion profiles, thus, represent motion sequences of the consumers. The motion profiles of the individual consumers can be different from each other in this case. Preferably it is here provided that the pumps can be controlled in dependence of the motion profiles of the open or closed loop control unit. If the different consumer parameters (feeding volumes and/or areal ration) as well as the desired different motion requirements (motion profiles) are known, these can be used by the open or closed loop control unit for an exact positioning with an according repeat accuracy. Thus, the open or closed loop control unit considers autonomously the at least two (different) consumers and their motion requirements.

According to a preferred embodiment it is provided that the positioning of the consumers is only effected by the corresponding (intelligent) control of the at least two pumps via the open or closed loop control unit. Preferably it is also provided that the direction control of the consumers is only effected via the at least two pumps. This means, no valves (or no control of the valves) are necessary for the positioning of the pumps or for the direction control of the consumers.

According to a further preferred embodiment it is provided that process-relevant parameters are considered by the open or closed loop control unit of the hydraulic device. Examples for process-relevant parameters are mass changes, the oil temperature, viscosity changes or friction coefficients in the form of friction changes. Based on changed process parameters (as for examples pressures, velocities, etc.), which are known anyway, it can be extrapolated that miscellaneous influences (friction, mass, viscosity) have been changed. The open or closed loop control unit, thus, reacts autonomously to these changes. No additional sensors are necessary. The following examples can be noted: If the pressure profile changes for a particular movement without an exchange of a forming tool being made, the friction in the system has changed. This change can be calculated by the open or closed loop control unit and is considered correspondingly in the further control or regulation. If the velocity of the movement changes during a constant control, this can be caused by temperature or viscosity changes. Thereby, the open or closed loop control unit intervenes in the motion sequence of the pumps (and in dependence therefrom of the consumers) in such a way that the process accuracy and the process reliability is still guaranteed. Hence, a permanent adaptation and adjustment of the control sequence to changing conditions is effected.

In principle it is possible that at least two of the consumers are simultaneously impinged by one or both pumps. For this purpose, however, corresponding bifurcations p. e. in the form of valves are necessary which then again take on the dispensation. In order to more efficiently arranging this and in order to spare additionally costly components, it is preferably provided that the consumers can be sequentially impinged by the hydraulic fluid via the two pumps.

Further it can be provided that the hydraulic device comprises more than two pumps. Also complete groups of pumps can be provided which can be driven individually or which can also be controlled as a group.

Preferably, constant or adjusting pumps can be used as pumps.

If the consumers are formed as piston-cylinder units, they can be formed as synchronous cylinders (areal ratio 1:1) or as differential cylinders (different areal ratios).

The valves cannot only be formed as 2/2-way valves but can also be provided in the form of seat valves, whereby the pressure can be “locked up”. This is not possible with 4/3-way valves.

The size of the pumps is designed to the driven consumers. In particular, the design of the pump is determined in dependence of the largest consumer. Thereby, also all smaller consumers—in particular in the case of a sequential control—can be driven therewith.

Protection is finally also sought for a molding machine with a hydraulic device according to the invention. Such a molding machine can be formed for example in the form of an injection molding machine or an injection press. Such a molding machine can of course comprise a plurality of such hydraulic devices.

Further details and advantages of the present invention are described more fully hereinafter by means of the specific description with reference to the embodiments illustrated in the drawings, in which:

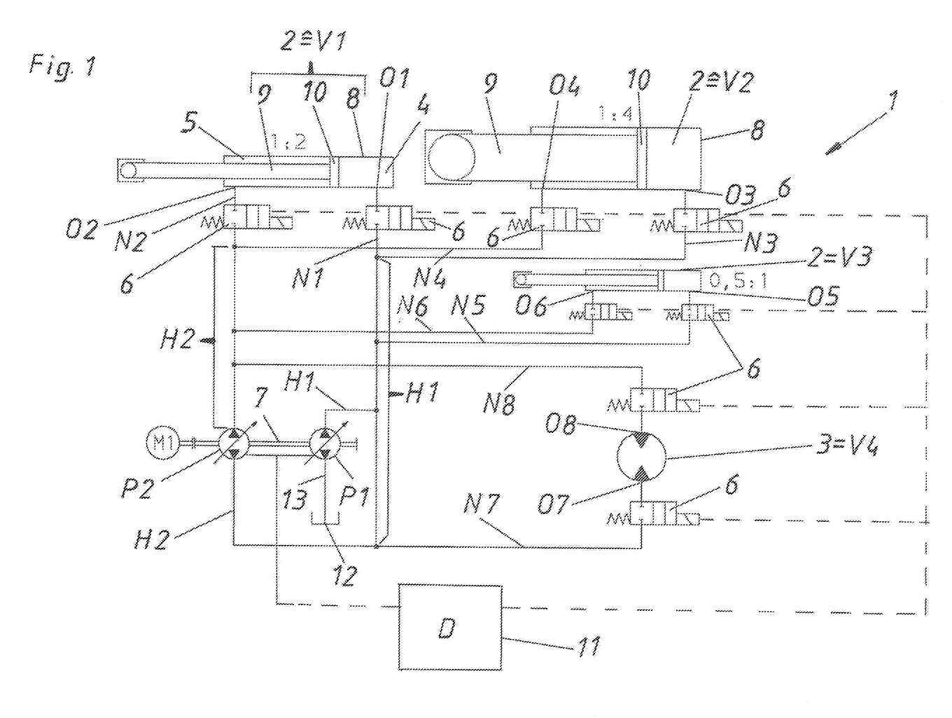

FIG. 1 schematically shows a hydraulic device with several consumers and an open or closed loop control unit,

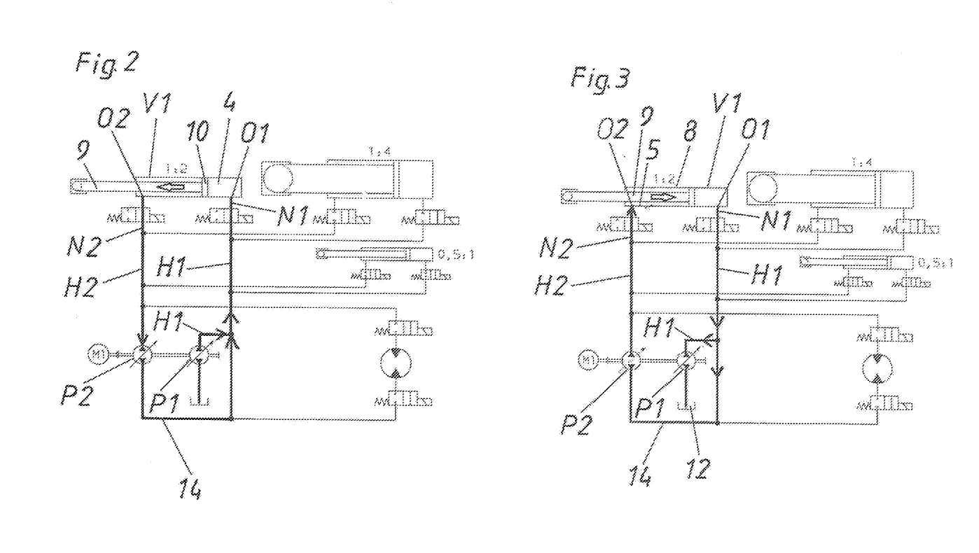

FIG. 2 shows the hydraulic device according to FIG. 1 when extending the first consumer,

FIG. 3 shows the hydraulic device according to FIG. 1 when retracting the first consumer,

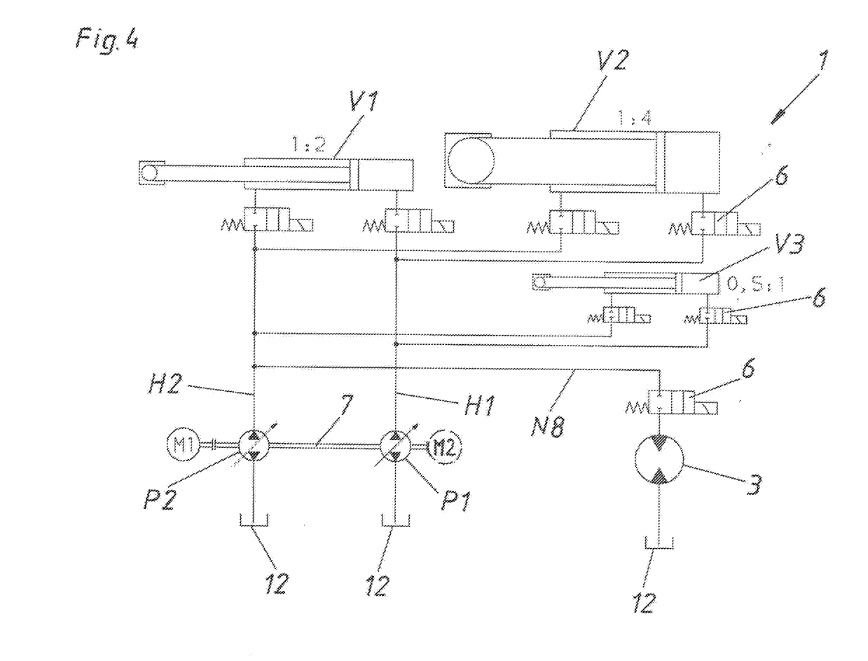

FIG. 4 schematically shows a hydraulic device with again several consumers in an open circulation,

FIG. 5 shows the hydraulic device according to FIG. 4 when extending the second consumer and

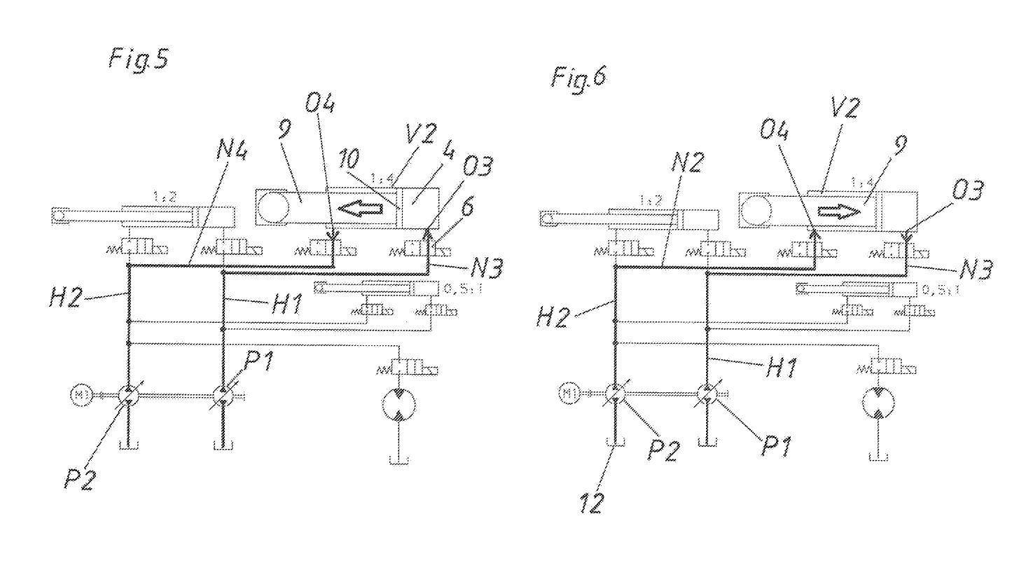

FIG. 6 shows the hydraulic device according to FIG. 4 when retracting the second consumer.

FIG. 1 shows a hydraulic device 1 which in total comprises four consumers V1-V4. There, the first three consumers V1-V3 are each formed as piston-cylinder units 2, whereas the fourth consumer V4 is formed as hydro motor 3. The piston-cylinder units 2 each comprise a cylinder 8 and a piston 10 together with rod 9 guided in the cylinder 8. The displayed piston-cylinder units 2 are each formed as differential cylinders with different areal ratios (1:2, 1:4 and 0.5:1).

Further displayed in FIG. 1 are a first pump P1 and a second pump P2. Both pumps P1 and P2 are driven in this case by a drive device M1 via a common shaft 7. Only the first pump P1 is connected to the tank 12 for hydraulic fluid via an according tank conduit 13. The first pump P1 can suck and refill hydraulic fluid from this tank 12 via the tank conduit 13. The first main conduit H1 leads away from the first pump P1. Subsequently the first main conduit H1 is connected with the sub-conduits N1, N3, N5 and N7, each of which lead to one of the consumers V1-V4. Valves 6, in this case 2/2-way valves, are arranged in these sub-conduits N1, N3, N5 and N7. The sub-conduits N1, N3, N5 and N7 each enter via an opening O1, O3, O5 and O7 in one of the consumers V1-V4. Concretely, each of the openings O1, O3 and O5 lead in a piston-sided cavity 4 in the cylinder 8 of the respective piston-cylinder units 2. In contrast, the sub-conduits N2, N4 and N6 lead to the rod-sided cavities 5 of the respective piston-cylinder unit 2 via the opening O2, O4 and O6. In an analogous manner the sub-conduit 8 leads to the opening O8 of the hydro motor 3 (consumer V4). All of these sub-conduits N2, N4, N6 and N8 are each connected to the second main conduit H2 which finally leads to the second pump P2.

In this schematic hydraulic device 1 according to FIG. 1 also the open or closed loop control unit 11 is displayed. In this open or closed loop control unit 11 consumer-specific data like feeding volumes or areal ratios are stored. At least the two pumps P1 and P2 are controlled or regulated by this open or closed loop control unit 11. By the dashed line it is indicated that via this open or closed loop control unit 11 also, preferably all, valves 6 can be controlled or regulated.

For the function of the hydraulic device 1 it can be exemplary referred to the FIG. 2. For extending the rod 9 of the first consumer V1 the first pump P1, thus, draws hydraulic fluid from the tank 12 and feeds the hydraulic fluid into the first main conduit 1. As the valve 6 in the first sub-conduit N1 is switched correspondingly, the hydraulic fluid reaches the piston-sided cavity 4 of the first consumer V1 via the first opening O1, whereby the piston 10 is moved relative to the cylinder 8 (in this case to the left). By this movement also the hydraulic fluid located in the rod-sided cavity 5 is pressed into the second sub-conduit N2 via the second opening O2 in the cylinder 8. Subsequently, the hydraulic fluid reaches the second pump P2 via the second main conduit H2. In this second pump P2 an energy recovery is possible. As in this case the hydraulic device 1 is formed as a closed circulation, after the second pump P2 the hydraulic fluid again reaches the first main conduit H1 via the circulation conduit 14.

In FIG. 3 it is illustrated how the consumer is moved in the other direction. In this case the second pump P2 feeds the hydraulic fluid from the closed circulation via the second main conduit H2 to the second sub-conduit N2. From there the hydraulic fluid reaches the rod-sided cavity 5 via the second opening O2, whereby the piston 10 together with the rod 9 is moved relative to the cylinder 8 (in this case to the right). Thereby the hydraulic fluid is subsequently pressed from the piston-sided cavity 4 via the first opening O1 into the first sub-conduit N1. From there the hydraulic fluid again reaches the circulation conduit 14 via the first main conduit H1. Especially when the consumer is formed as a differential cylinder, the first pump P1 takes on the sucking off of the excessive hydraulic fluid into the tank 12. In the illustrated example the maximal stroke volume of the two pumps P1 and P2 have a ratio of 1:1. In order to be able exploit the pumps optimally, these ratios can be adapted to the present system of consumers and, thus, can vary for different systems.

In FIG. 4 a slightly modified embodiment of the hydraulic device 1 is illustrated schematically. In this case the hydraulic device 1 is formed as an open circulation, wherein both the two pumps P1 and P2 and the hydro motor 3 are each connected to a separate tank 12. Should the two pumps P1 and P2 not be driven by a drive device M1 via a common shaft 7, also a separate drive device M2 (schematically indicated) can be provided. A difference in this FIG. 4 can also be seen in that the hydro motor 3 is connected to the second main conduit H2 only via the sub-conduit N8. An open or closed loop control unit 11 can of course be used in FIG. 4 in the same manner as in FIG. 1. Apart from that, the hydraulic device 1 according to FIG. 4 is identical to the hydraulic device 1 according to FIG. 1.

For the functionality of this hydraulic device 1 it can be referred to the FIGS. 5 and 6, wherein the sequence of the movement of the consumer V2 is effected analogous to the movement of the consumer V1 according to FIGS. 2 and 3. In particular, according to FIG. 5 the hydraulic fluid (hydraulic oil) is led from the first pump P1 via the first main conduit H1 and—due to the accordingly switched valve 6—via the third sub-conduit N3 and the third opening O3 into the piston-sided cavity 4 of the second consumer V2, whereby the piston 10 together with the rod 9 is moved, preferably extended, (in this case) to the left. Thereby, hydraulic fluid is also pressed from the rod-sided cavity 5 via the fourth opening O4 into the fourth sub-conduit N4, from where the hydraulic fluid is further fed via the second main conduit H2 and the second pump P2 into the tank 12. As the piston-cylinder unit 2 of the second consumer V2 is formed as a differential cylinder with a ratio of 1:4, exemplary 100% of hydraulic fluid is fed by the first pump P1, whereas simultaneously 25% of hydraulic fluid is re-fed from the second pump P2 (provided that the two pumps P1 and P2 have the same stroke volume).

Contrary, only 25% of the feeding volume of the second pump P2 is required for the movement of the piston 10 of the second consumer V2 to the right in order to re-fed 100% of hydraulic fluid via the first pump P1, as it is the case according to FIG. 6. With this hydraulic device 1, thus, consumers with different areal ratios can be driven, preferably sequentially, in an easy manner. Consumers can also be driven in a closed or in an open circulation.

Generally it has yet to be noted that in a particularly preferred embodiment a third consumer V3 is provided which is connected to the first main conduit H1 via a fifth opening O5 and a fifth sub-conduit N5 and which is connected to the second main conduit H2 via a sixth opening O6 and a sixth sub-conduit N6. In addition, yet also a fourth consumer V4 can be provided which is connected to the first main conduit H1 via a seventh opening O7 and a seventh sub-conduit N7 and which is connected to the second main conduit H2 via an eighth opening O8 and an eighth sub-conduit N8. Preferably also these consumers V3 and V4 are driven sequentially by the pumps P1 and P2.

With other words the present invention can also be expressed as follows:

The present invention can particularly be used for multiple-axis systems. A central pumping station (servo motor+regulation pump) supplies several hydraulic axes (consumers V1-V4) via long conduits and corresponding switching elements (valves 6). Two regulation pumps (pumps P1 and P2), driven by an electro motor (asynchronous or synchronous motor), are used in order to drive a hydraulic actuator. The positioning of this actuator (consumer) is effected by a corresponding regulation. By the use of a second pump P2 there is the possibility of energy recovery. In order to be able to operate several hydraulic axes with one drive system, switching elements are necessary to direct the supply of the actuators correspondingly. In this case the axes do not have to be compact axes. In particular in the case of a use in an injection molding machine there is a central pumping station from which the consumers are supplied with long conduits. The control technology can be effected by a central open or closed loop control unit 11, whereby especially the switching between different consumers V1-V4 is carried out.

In particular the system can be formed in such a way that either a motor (drive device M1) with two regulation pumps (pumps P1 and P2) or two motors (drive devices M1 and M2) with constant pumps (pumps P1 and P2) are driving at least two consumers from the group of consumers V1-V4. The consumers V1-V4 can have different volume requirements and can be driven by volume and pressure control. Exemplary volume ratios of the cylinder chambers are illustrated in the drawings. The direction reversal is not implemented by way valves but is effected only by the control of the pumps P1 and P2. The different consumers from the group of consumers V1-V4 are driven preferably only sequentially. This is preferably effected by simple on-off valves, whereby the individual consumers V1-V4 are connected to or separated from the supplying system. Optionally, also seat valves can be used for this purpose in order to lock the position. Preferably the open or closed loop control unit possesses at each point of time the information which consumer from the group of consumers V1-V4 is driven. The movement is regulated or followed via ramps (force or way ramps).

In the case of the first variant according to the FIGS. 1 to 3 the hydraulic device 1 works in a semi-open circulation, wherein only one pump (first pump P1) is directly connected to the tank 12. This pump P1 compensates the different required amounts between the cylinder chambers 4 and 5. Thus, the first pump P1 sucks hydraulic fluid volume from the system if the piston 10 of the consumer is retracted and feeds hydraulic fluid volume into the system if the piston 10 is extended. In the case of this system the hydro motor 3 can be driven both in an open and in a closed circulation.

In the case of variant 2 (FIGS. 4 to 6) the hydraulic device 1 comprises two pumps P1 and P2 each of which is connected to the tank 12. Preferably the pumps P1 and P2 are used with different stroke volumes in order to enable an optimal adaptation to the different volume requirements of the respective cylinder chambers 4 and 5. In the case of this system the hydro motor 3 is driven in an open circulation.

With the present invention in contrast to the state of the art it is, thus, not only possible to drive one consumer but to drive several consumers. This is controlled or regulated in that one pump is switched to the intake side and the other pump is switched to the discharge side of the consumer. For the control direction of the further consumers no 4/3-way valves are responsible but via the pumps the desired movement direction follows depending on which pump is feeding and which pump is sucking. The separation of the consumers from the pressure is not effected by 4/3-way valves but by 2/2-way valves.

1. A hydraulic device for a molding machine, in particular an injection molding machine, comprising
a first pump for a hydraulic fluid,
at least a second pump for the hydraulic fluid,
at least one drive device for the first pump and the second pump,
a first main conduit which leads away from the first pump,
a second main conduit which leads away from the second pump,
a first consumer which is connected with the first main conduit via a first opening and a first sub-conduit and which is connected with the second main conduit via a second opening and a second sub-conduit, and
at least one second consumer which is also connected with one of the main conduits via a third opening and a third sub-conduit,
wherein the second consumer on the one hand is connected with the first main conduit via the third opening and the third sub-conduit and on the other hand is connected with the second main conduit via a fourth opening and a fourth sub-conduit.

2. The hydraulic device according to claim 1, wherein the consumers are formed as piston-cylinder units or as hydro motors.

3. The hydraulic device according to claim 2, wherein the first and third opening each lead to a piston-sided cavity in the cylinder of the respective piston-cylinder unit and the second and fourth opening each lead to a rod-sided cavity in the cylinder of the respective piston-cylinder unit.

4. The hydraulic device according to claim 1, wherein valves, preferably 2/2-way valves, are arranged in each sub-conduit.

5. The hydraulic device according to claim 1, wherein the at least one drive device, which is preferably formed as an electro or hydro motor, drives both pumps.

6. The hydraulic device according to claim 5, wherein both pumps are connected with the one drive device via a common shaft.

7. The hydraulic device according to claim 1, wherein at least two drive devices are provided, wherein each drive device each drives one of the pumps.

8. The hydraulic device according to claim 1, wherein an open or closed loop control unit for controlling or regulating the pumps is provided.

9. The hydraulic device according to claim 8, wherein also the valves can be controlled via the open or closed loop control unit.

10. The hydraulic device according to claim 8, wherein consumer-specific data, for example feeding volumes and/or areal ratios of the consumers, are stored in the open or closed loop control unit.

11. The hydraulic device according to claim 10, wherein the pumps can be controlled by the open or closed loop control unit in dependence of the consumer-specific data.

12. The hydraulic device according to one of the claim 8, wherein the pumps can be controlled by the open or closed loop control unit in dependence of motion profiles of the consumers, preferably stored in a memory.

13. The hydraulic device according to claim 1, wherein the consumers can be sequentially pressurized by the hydraulic fluid via the two pumps.

14. A molding machine, in particular an injection molding machine, comprising a hydraulic device according to claim 1.
